(19) United States
(12) Patent Application Publication
(10) Pub. No.: US 2026/0148711 A1
(43) Pub. Date: May 28, 2026

(54) BACKLIGHT DIMMING CIRCUIT, BACKLIGHT SYSTEM, AND ELECTRONIC DEVICE

(71) Applicants: Huayuan Semiconductor (Shenzhen) Limited Company, Shenzhen (CN); Huayuan Semiconductor (Tianjin) Limited Company, Tianjin (CN)

(72) Inventors: Junyue SUN, Tianjin (CN); Honglai WANG, Tianjin (CN); Xianbin LIAO, Shenzhen (CN); Haiming YU, Shenzhen (CN); Yuting FANG, Tianjin (CN)

(73) Assignees: Huayuan Semiconductor (Shenzhen) Limited Company, Shenzhen (CN); Huayuan Semiconductor (Tianjin) Limited Company, Tianjin (CN)

(21) Appl. No.: 19/453,520

(22) Filed: Jan. 20, 2026

Related U.S. Application Data
(63) Continuation of application No. PCT/CN2024/115607, filed on Aug. 29, 2024.

(30) Foreign Application Priority Data
Nov. 21, 2023 (CN) 2023115722724

(51) Int. Cl. G09G 3/34

(52) U.S. Cl. CPC G09G 3/3426; G09G 2310/0291; G09G 2320/0233; G09G 2320/0247

(57) ABSTRACT

A backlight dimming circuit provides backlight by LED string; a local dimming module controls a grayscale level of the LED string; a current peak adjustment module adjusts a value of a peak output current flowing through the LED string; a drain of a first MOS transistor in a feedback module is coupled to a second terminal of the LED string, a source of which is grounded a first input terminal of an operational amplifier is coupled to a first terminal of the current peak adjustment module or a first terminal of the local dimming module, a second input terminal of the operational amplifier is coupled to the first terminal of the local dimming module or the first terminal of the current peak adjustment module, an output terminal of the operational amplifier is coupled to a gate of the first MOS transistor.

### TECHNICAL FIELD

The present invention relates to the field of display technologies, and in particular, to a backlight dimming circuit, a backlight system, and an electronic device.

### BACKGROUND

With the development of display technologies, Miniled backlighting has been increasingly applied in liquid crystal display systems. Each time a liquid crystal display (lcd, liquid crystal display) refreshes and displays one frame of image, liquid crystal molecules undergo reorientation. If a backlight display system and a liquid crystal panel are not properly coordinated, phenomena such as ghosting, trailing, and blurring may occur on a displayed image. To resolve this problem, black frame insertion (BFI) in a dynamic blurring processing technology is increasingly applied to a display system.

In actual applications, if a backlight controller of the display system receives a VSync signal (vertical synchronization signal), the backlight controller sends dimming data to each driver chip in the backlight system. The driver chip outputs a current based on the dimming data to drive Miniled beads. Referring to FIG. 1, in a black frame insertion (BFI) mode, the driver chip outputs intermittent PWM current waveforms, where a current output by the driver chip during black frame insertion is 0, and when backlight is illuminated, the driver chip outputs a corresponding current value based on global or local dimming data. In addition, on a display screen, reorientation time of each row of liquid crystals varies from the top to the bottom, and therefore, a time start point for inserting a black frame into each row needs to be different.

However, because time for inserting a black frame in a time period of one data frame is long, and time for effectively outputting a current by backlight is short, overall brightness of the backlight system is significantly reduced in the black frame insertion mode, leading to a decrease in the brightness of the displayed image.

Therefore, how to improve display brightness of the backlight system in the black frame insertion mode without affecting a regional dimming signal has become a technical problem that needs to be urgently resolved in the industry.

### SUMMARY

The present invention provides a backlight dimming circuit, a backlight system, and an electronic device, so as to resolve a technical problem of how to improve display brightness of the backlight system in a black frame insertion mode without affecting a regional dimming signal.

According to a first aspect of the present invention, a backlight dimming circuit for adjusting a peak output current flowing through an LED string in a black frame insertion mode is provided, including a local dimming module, a current peak adjustment module, and a feedback module, where
the LED string includes N LEDs connected in series, a first terminal of the LED string is coupled to a first voltage source, and the LED string is configured to provide backlight for a screen, where N is an integer greater than or equal to 1;
the local dimming module includes a total of M local dimming units and configured to: receive a local dimming signal, and correspondingly control, based on the local dimming signal, i local dimming units to be connected in parallel, so as to control a grayscale level of the LED string, where the local dimming signal includes dimming data information, M and i are integers, 1≤M, and 0≤i≤M;
the current peak adjustment module is configured to: receive a current peak adjustment signal and a backlight mode signal, and adjust, based on the current peak adjustment signal and the backlight mode signal, a value of the peak output current flowing through the LED string, where the current peak adjustment signal includes current adjustment coefficient information, and the backlight mode signal includes backlight mode information; and
the feedback module includes a first MOS transistor and an operational amplifier, and is configured to control a voltage at a first terminal of the local dimming module to be equal to a voltage at a first terminal of the current peak adjustment module, where
a drain of the first MOS transistor is coupled to a second terminal of the LED string, and a source of the first MOS transistor is grounded by using the local dimming module or the current peak adjustment module; and
a first input terminal of the operational amplifier is coupled to the first terminal of the current peak adjustment module or the first terminal of the local dimming module, a second input terminal of the operational amplifier is coupled to the first terminal of the local dimming module or the first terminal of the current peak adjustment module, and an output terminal of the operational amplifier is coupled to a gate of the first MOS transistor.

Optionally, the current peak adjustment module includes a total of J current peak adjustment units; and
the current peak adjustment module is further configured to correspondingly control, based on the current peak adjustment signal, k current peak adjustment units to be connected in parallel, so as to adjust the value of the peak output current flowing through the LED string, where J and k are integers, 1≤J, and 0≤k≤J.

Optionally, the current peak adjustment unit includes a first resistor and a first switch; and
a first terminal of each first resistor is coupled to the source of the first MOS transistor, and a second terminal of each first resistor is grounded by using the corresponding first switch.

Optionally, the local dimming module is further configured to output a first signal to the first input terminal of the operational amplifier based on the local dimming signal, where the first signal is used to represent the grayscale level of the LED string.

Optionally, the current peak adjustment unit includes a second MOS transistor; and
a drain of each second MOS transistor is coupled to the source of the first MOS transistor, and a source of each second MOS transistor is grounded.

Optionally, the correspondingly controlling, based on the current peak adjustment signal, k current peak adjustment units to be connected in parallel is specifically:
correspondingly controlling, based on the current peak adjustment signal, gates of k second MOS transistors to be connected in sequence.

Optionally, the backlight dimming circuit further includes a third MOS transistor, where
a drain of the third MOS transistor is coupled to the first terminal of the local dimming module, a source of the third MOS transistor is grounded, and a gate of the third MOS transistor is respectively coupled to a gate of a 1^{st} second MOS transistor and the drain of the third MOS transistor, and a second terminal of the local dimming module is coupled to a second voltage source.

Optionally, the local dimming unit includes a fifth MOS transistor; and
a drain of each fifth MOS transistor is coupled to the source of the first MOS transistor, and a source of each fifth MOS transistor is grounded.

Optionally, the correspondingly controlling, based on the local dimming signal, i local dimming units to be connected in parallel is specifically:
correspondingly controlling, based on the local dimming signal, gates of i fifth MOS transistors to be connected in sequence.

Optionally, the backlight dimming circuit further includes a fourth MOS transistor, and the current peak adjustment unit includes a current source unit and a second switch;
a first terminal of each current source unit is coupled to a third voltage source, and a second terminal of each current source unit is respectively coupled to the first input terminal of the operational amplifier and a drain of the fourth MOS transistor by using the corresponding second switch; and
a source of the fourth MOS transistor is grounded, and a gate of the fourth MOS transistor is respectively coupled to a gate of an i^{th} fifth MOS transistor and the drain of the fourth MOS transistor.

Optionally, the current peak adjustment module includes a multiplexer and a voltage adjustment unit;
an input terminal of the voltage adjustment unit receives the current peak adjustment signal and outputs a second reference voltage based on the current peak adjustment signal;
a first terminal of the multiplexer receives a first reference voltage, a second terminal of the multiplexer receives the second reference voltage, an output terminal of the multiplexer is coupled to the first input terminal of the operational amplifier, and a control terminal of the multiplexer receives the backlight mode signal, where a voltage value of the second reference voltage is greater than a voltage value of the first reference voltage; and
the multiplexer is configured to:
if the backlight mode information indicates a normal working mode, control the output terminal of the multiplexer to output the first reference voltage; and
if the backlight mode information indicates a black frame insertion mode, control the output terminal of the multiplexer to output the second reference voltage.

Optionally, the local dimming unit includes a second resistor and a third switch; and
a first terminal of each second resistor is coupled to the source of the first MOS transistor, and a second terminal of each second resistor is grounded by using the corresponding third switch.

Optionally, the backlight dimming circuit further includes an isolation MOS transistor; and
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

According to a second aspect of the present invention, a backlight system is provided, including the LED string and the backlight dimming circuit provided in any implementation of the first aspect of the present invention.

According to a third aspect of the present invention, an electronic device is provided, including the backlight dimming circuit provided in any implementation of the first aspect of the present invention.

In the backlight dimming circuit, the backlight system, and the electronic device provided in the present invention, the circuit provides backlight for a screen by using an LED string, a local dimming module controls a grayscale level of the LED string, a current peak adjustment module adjusts a value of a peak output current flowing through the LED string, and a feedback module controls a voltage at a first terminal of the local dimming module to be equal to a voltage at a first terminal of the current peak adjustment module. A drain of a first MOS transistor is coupled to a second terminal of the LED string, and a source of the first MOS transistor is grounded by using the local dimming module or the current peak adjustment module. A first input terminal of an operational amplifier is coupled to the first terminal of the current peak adjustment module or the first terminal of the local dimming module, a second input terminal of the operational amplifier is coupled to the first terminal of the local dimming module or the first terminal of the current peak adjustment module, and an output terminal of the operational amplifier is coupled to a gate of the first MOS transistor. Therefore, display brightness of the backlight system in a black frame insertion mode is improved by adjusting the value of the peak output current flowing through the LED string without affecting a local dimming signal.

### BRIEF DESCRIPTION OF DRAWINGS

To describe the technical solutions in the embodiments of the present invention or the prior art more clearly, the following briefly describes the accompanying drawings needed for describing the embodiments or the prior art. Clearly, the accompanying drawings in the following descriptions show merely some embodiments of the present invention, and a person of ordinary skill in the art can still derive other accompanying drawings from these accompanying drawings without creative efforts.

FIG. 1 is a schematic structural diagram of a backlight dimming circuit according to an embodiment of the present invention;

FIG. 2 is a schematic structural diagram of a backlight dimming circuit according to a first embodiment of the present invention;

FIG. 3 is a schematic structural diagram of a backlight dimming circuit according to a second embodiment of the present invention;

FIG. 4 is a schematic structural diagram of a backlight dimming circuit according to a third embodiment of the present invention;

FIG. 5 is a schematic structural diagram of a backlight dimming circuit according to a fourth embodiment of the present invention;

FIG. 6 is a schematic structural diagram of a backlight dimming circuit according to a fifth embodiment of the present invention;

FIG. 7 is a waveform diagram of a backlight dimming circuit in a working state in the prior art; and

FIG. 8 is a waveform diagram of a backlight dimming circuit in FIG. 1 in a working state.

### Description of Reference Numerals

10—LED string;
20—Local dimming module;
30—Current peak adjustment module;
40—Feedback module;
M1—First MOS transistor;
M2—Second MOS transistor;
M3—Third MOS transistor;
M4—Fourth MOS transistor;
M5—Fifth MOS transistor;
101—Operational amplifier;
Vdcdc—First voltage source;
VCC1—Second voltage source;
VCC2—Third voltage source;
R1—First resistor;
R2—Second resistor;
SW1—First switch;
SW2—Second switch;
SW3—Third switch;
301—Multiplexer;
302—Voltage adjustment unit;
Vref1—First reference voltage;
Vref2—Second reference voltage;
HV—Isolation MOS transistor.

### DESCRIPTION OF EMBODIMENTS

The technical solutions in embodiments of the present invention are clearly and completely described below with reference to the accompanying drawings in the embodiments of the present invention. Clearly, the described embodiments are merely some rather than all of the embodiments of the present invention. All other embodiments obtained by a person of ordinary skill in the art based on the embodiments of the present invention without creative efforts shall fall within the protection scope of the present invention.

Terms “first”, “second”, “third”, “fourth” and the like (if they exist) in the description, claims and foregoing accompanying drawings of the present invention are used for distinguishing similar objects and not for describing a specific order or sequence. It should be understood that the terms used in this way may be interchanged where appropriate, so that the embodiments of the present invention described herein can be implemented in a sequence other than what is illustrated or described herein. In addition, the terms “include” and “have” and any modifications to them are intended to cover non-exclusive inclusion, for example, processes, methods, systems, products, or devices that contain a series of steps or units are not necessarily limited to those steps or units that are clearly listed, but may include other steps or units that are not clearly listed or are inherent to these processes, methods, products, or devices.

The technical solutions of the present invention are described below in detail by using specific embodiments. The following specific embodiments may be combined with each other, and same or similar concepts or processes may not be described repeatedly in some embodiments.

There is the following technical problem in the prior art: It is very difficult to improve display brightness of a backlight system in a black frame insertion mode without affecting a regional dimming signal. In the backlight dimming circuit, the backlight system, and the electronic device provided in the present invention, the circuit provides backlight for a screen by using an LED string, a local dimming module controls a grayscale level of the LED string, a current peak adjustment module adjusts a value of a peak output current flowing through the LED string, and a feedback module controls a voltage at a first terminal of the local dimming module to be equal to a voltage at a first terminal of the current peak adjustment module. A drain of a first MOS transistor is coupled to a second terminal of the LED string, and a source of the first MOS transistor is grounded by using the local dimming module or the current peak adjustment module. A first input terminal of an operational amplifier is coupled to the first terminal of the current peak adjustment module or the first terminal of the local dimming module, a second input terminal of the operational amplifier is coupled to the first terminal of the local dimming module or the first terminal of the current peak adjustment module, and an output terminal of the operational amplifier is coupled to a gate of the first MOS transistor. Therefore, display brightness of the backlight system in a black frame insertion mode is improved by adjusting the value of the peak output current flowing through the LED string without affecting a local dimming signal.

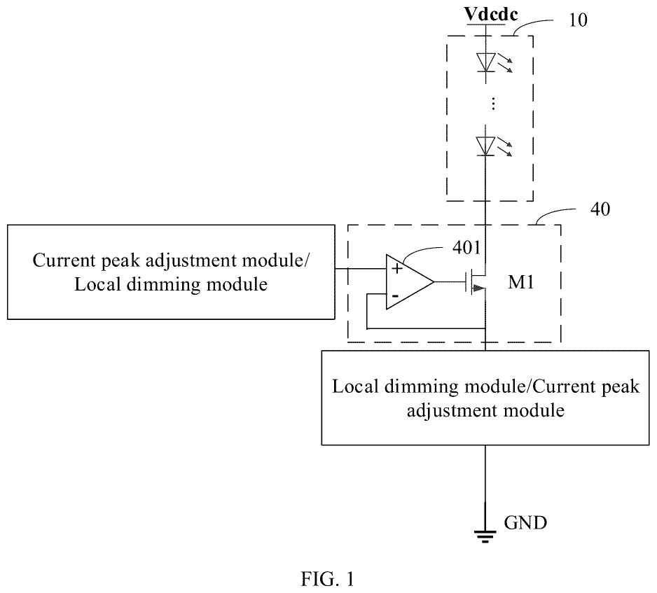

Referring to FIG. 1, an embodiment of the present invention provides a backlight dimming circuit for adjusting a peak output current flowing through an LED string 10 in a black frame insertion mode, and the backlight dimming circuit includes a local dimming module 20, a current peak adjustment module 30, and a feedback module 40.

The LED string 10 includes N LEDs connected in series, a first terminal of the LED string is coupled to a first voltage source Vdcdc, and the LED string 10 is configured to provide backlight for a screen, where N is an integer greater than or equal to 1.

The local dimming module 20 includes a total of M local dimming units and is configured to: receive a local dimming signal, and correspondingly control, based on the local dimming signal, i local dimming units to be connected in parallel, so as to control a grayscale level of the LED string 10, where the local dimming signal includes dimming data information, M and i are integers, 1≤M, and 0≤i≤M.

The current peak adjustment module 30 is configured to: receive a current peak adjustment signal and a backlight mode signal, and adjust, based on the current peak adjustment signal and the backlight mode signal, a value of the peak output current flowing through the LED string 10, where the current adjustment signal includes current adjustment coefficient information, and the backlight mode signal includes backlight mode information.

The feedback module 40 includes a first MOS transistor M1 and an operational amplifier 101, and is configured to control a voltage at a first terminal of the local dimming module 20 to be equal to a voltage at a first terminal of the current peak adjustment module 30, where
a drain of the first MOS transistor M1 is coupled to a second terminal of the LED string 10, and a source of the first MOS transistor M1 is grounded by using the local dimming module 20 or the current peak adjustment module 30; and
a first input terminal of the operational amplifier 101 is coupled to the first terminal of the current peak adjustment module 30 or the first terminal of the local dimming module 20, a second input terminal of the operational amplifier is coupled to the first terminal of the local dimming module 20 or the first terminal of the current peak adjustment module 30, and an output terminal of the operational amplifier is coupled to a gate of the first MOS transistor M1.

Controlling the voltage at the first terminal of the local dimming module 20 to be equal to the voltage at the first terminal of the current peak adjustment module 30 utilizes a characteristic of a virtual short-circuit between a non-inverting input terminal and an inverting input terminal of the operational amplifier 101. In this way, a current flowing through the LED string 10 can be more conveniently controlled. In an example, the first input terminal of the operational amplifier 101 is the inverting input terminal, and the second input terminal of the operational amplifier 101 is the non-inverting input terminal.

In the example shown in FIG. 1, the first MOS transistor M1 is an NMOS transistor. Certainly, this is not limited in the present invention, and an IGBT transistor or the like may also be used.

As for the current adjustment coefficient information, it should be understood that, in actual use, the current adjustment coefficient information may be defined based on parameters of each screen, which is not limited in the present invention.

A specific composition of the current peak adjustment module 30 and a specific composition of the local dimming module 20 are described. It should be understood that a specific combination form of circuits is not limited in the present invention. Circuits in the local dimming module 20 in various embodiment may be exchanged, and circuits in the current peak adjustment module 30 may also be exchanged.

In an implementation, the current peak adjustment module 30 includes a total of J current peak adjustment units.

The current peak adjustment module 30 is further configured to correspondingly control, based on the current peak adjustment signal, k current peak adjustment units to be connected in parallel, so as to adjust the value of the peak output current flowing through the LED string 10, where J and k are integers, 1≤J, and 0≤k≤J.

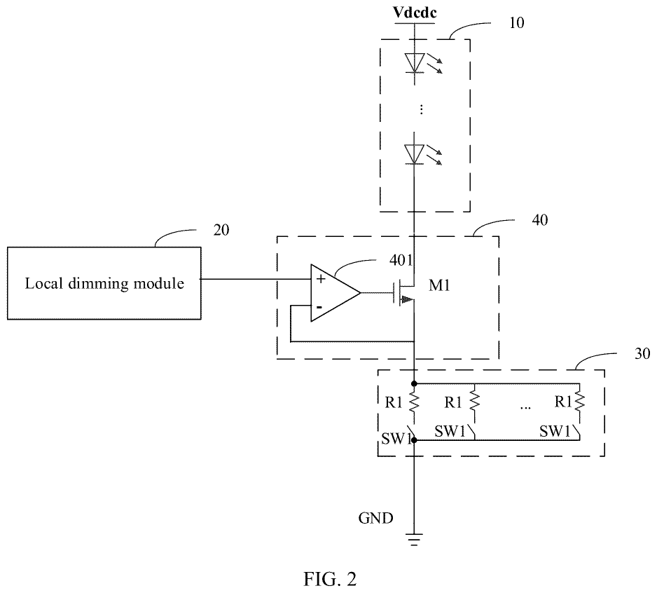

On this basis, in a specific implementation, referring to FIG. 2, the current peak adjustment unit includes a first resistor R1 and a first switch SW1; and
a first terminal of each first resistor R1 is coupled to the source of the first MOS transistor M1, and a second terminal of each first resistor R1 is grounded by using the corresponding first switch SW1.

Certainly, a specific connection form is not limited in the present invention. In another specific implementation, a first terminal of each first switch SW1 is coupled to the source of the first MOS transistor M1, and a second terminal of each first switch SW1 is grounded by using the corresponding first resistor R1.

The current peak adjustment module 30 is further configured to control to close k first switches SW1 based on the current peak adjustment signal, so as to control the value of the peak output current flowing through the LED string 10.

In this case, the local dimming module 20 is further configured to output a first signal to the first input terminal of the operational amplifier 101 based on the local dimming signal, where the first signal is used to represent the grayscale level of the LED string 10.

In some examples, the local dimming unit is a resistor, and the local dimming module 20 correspondingly controls, based on the local dimming signal, i local dimming units to be connected in series, or controls resistors of different resistance values to be coupled to the first input terminal of the operational amplifier 101 so as to control the grayscale level of the LED string.

In this embodiment, the first signal may be understood as a voltage value, and the voltage value is used to represent the grayscale level of the LED string 10. Because the voltage at the first terminal of the local dimming module 20 is equal to the voltage at the first terminal of the current peak adjustment module 30,
if a quantity of first resistors R1 connected in parallel in the current peak adjustment module 30 remains unchanged, the current flowing through the LED string 10 changes with a corresponding grayscale level; and
if a voltage value corresponding to the first signal remains unchanged, the current flowing through the LED string 10 changes with the quantity of first resistors R1 connected in parallel in the current peak adjustment module 30.

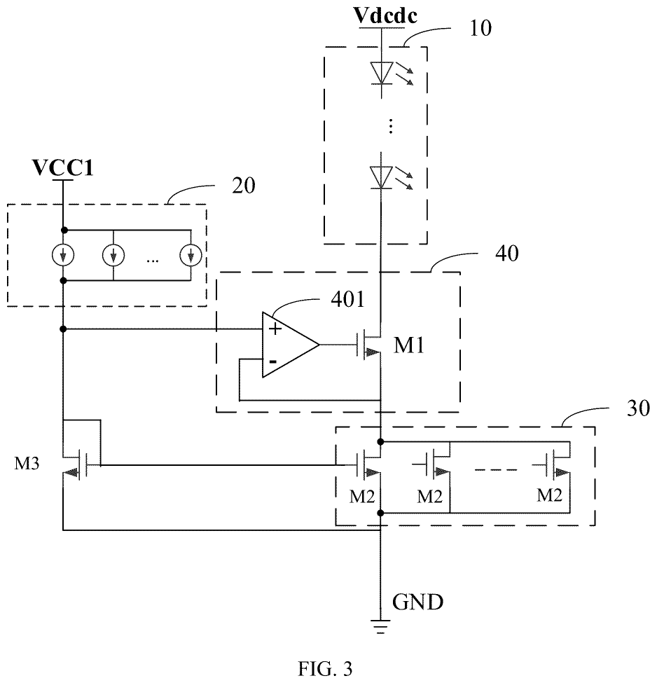

In another specific implementation, referring to FIG. 3, the local dimming unit may be a current source (the local dimming module 20 may control a quantity of current sources connected in parallel). On this basis, the current flowing through the LED string 10 may be controlled by using a current output by the local dimming module 20.

In an implementation, the current peak adjustment unit includes a second MOS transistor M2; and
a drain of each second MOS transistor M2 is coupled to the source of the first MOS transistor M1, and a source of each second MOS transistor M2 is grounded.

In this case, the correspondingly controlling, based on the current peak adjustment signal, k current peak adjustment units to be connected in parallel is specifically:
correspondingly controlling, based on the current peak adjustment signal, gates of k second MOS transistors M2 to be connected in sequence.

The k second MOS transistors M2 connected in parallel may be considered as a single MOS transistor, and a width-to-length ratio of the single MOS transistor is equivalent to k times a width-to-length ratio of the second MOS transistor M2. To use this characteristic, in an implementation, the backlight dimming circuit further includes a third MOS transistor M3; and
a drain of the third MOS transistor M3 is coupled to the first terminal of the local dimming module 20, a source of the third MOS transistor M3 is grounded, and a gate of the third MOS transistor M3 is respectively coupled to a gate of a 1^{st} second MOS transistor M2 and the drain of the third MOS transistor M3.

Certainly, a specific manner of connecting second MOS transistors M2 in parallel is not limited in the present invention. In another implementation, the current peak adjustment module may alternatively be as follows:
a drain of each second MOS transistor M2 is coupled to the source of the first MOS transistor M1 by using a switch, gates of the second MOS transistors M2 are connected, and a source of each second MOS transistor M2 is grounded.

In another implementation, the current peak adjustment module may alternatively be as follows:
a drain of each second MOS transistor M2 is coupled to the source of the first MOS transistor M1, gates of the second MOS transistors M2 are connected, and a source of each second MOS transistor M2 is grounded by using a switch.

In this case, the correspondingly controlling, based on the current peak adjustment signal, k current peak adjustment units to be connected in parallel may alternatively be specifically:
correspondingly controlling, based on the current peak adjustment signal, drains or sources of k second MOS transistors M2 to be connected in sequence.

In the example of FIG. 3, a second terminal of the local dimming module 20 is coupled to a second voltage source VCC1. In an actual circuit, a voltage value of a voltage provided by the second voltage source VCC1 is generally less than a voltage value of a voltage provided by the first voltage source Vdcdc.

In this embodiment, the third MOS transistor M3 and the current peak adjustment module 30 constitute a current mirror, and in this case,
if a quantity of second MOS resistors M2 connected in parallel in the current peak adjustment module 30 remains unchanged, the grayscale level of the current flowing through the LED string 10 changes with a current output by the local dimming module 20; and
if a value of the current output by the local dimming module 20 remains unchanged, the value of the current flowing through the LED string 10 changes with the quantity of second MOS transistor M2 connected in parallel in the current peak adjustment module 30.

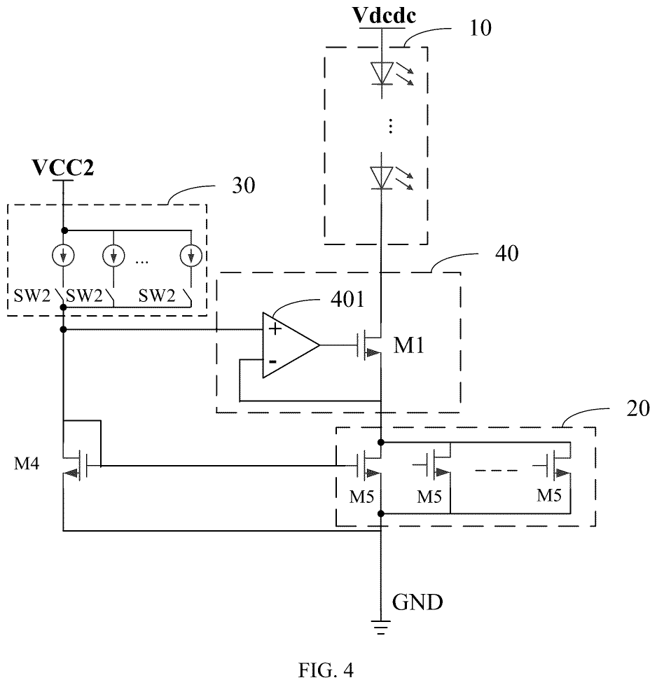

In still another specific implementation, referring to FIG. 4, the local dimming unit includes a fifth MOS transistor M5; and
a drain of each fifth MOS transistor M5 is coupled to the source of the first MOS transistor M1, and a source of each fifth MOS transistor M5 is grounded.

In this case, the correspondingly controlling, based on the local dimming signal, i local dimming units to be connected in parallel is specifically:
correspondingly controlling, based on the local dimming signal, gates of i fifth MOS transistors M5 to be connected in sequence.

Similarly, a characteristic that a width-to-length ratio of a single MOS transistor formed by i fifth MOS transistors M5 is equivalent to i times a width-to-length of the fifth MOS transistor M5 may be used. In an implementation, the backlight dimming circuit further includes a fourth MOS transistor M4. The current peak adjustment unit includes a current source unit and a second switch SW2.

A first terminal of each current source unit is coupled to a third voltage source VCC2, and a second terminal of each current source unit is respectively coupled to the first input terminal of the operational amplifier 101 and a drain of the fourth MOS transistor M4 by using the corresponding second switch SW2.

A source of the fourth MOS transistor M4 is grounded, and a gate of the fourth MOS transistor M4 is respectively coupled to a gate of an i^{th} fifth MOS transistor M5 and the drain of the fourth MOS transistor M4.

In an actual circuit, a voltage value of a voltage provided by the third voltage source VCC2 is generally less than the voltage value of the voltage provided by the first voltage source Vdcdc.

The current peak adjustment module 30 is further configured to control to close k second switches SW2 based on the current peak adjustment signal, so as to control the value of the peak output current flowing through the LED string 10.

In this embodiment, the fourth MOS transistor M4 and the local dimming module 20 constitute a current mirror, and in this case,
if a value of a current output by the current peak adjustment module 30 to the fourth MOS transistor M4 remains unchanged, the current flowing through the LED string 10 changes with a quantity of fifth MOS transistors M5 connected in parallel, where the quantity of fifth MOS transistors M5 connected in parallel corresponds to different grayscale levels; and
if the quantity of fifth MOS transistors M5 connected in parallel in the local dimming module 20 remains unchanged, the current flowing through the LED string 10 changes with a value of a current output by the current peak adjustment module 30 to the fourth MOS transistor M4.

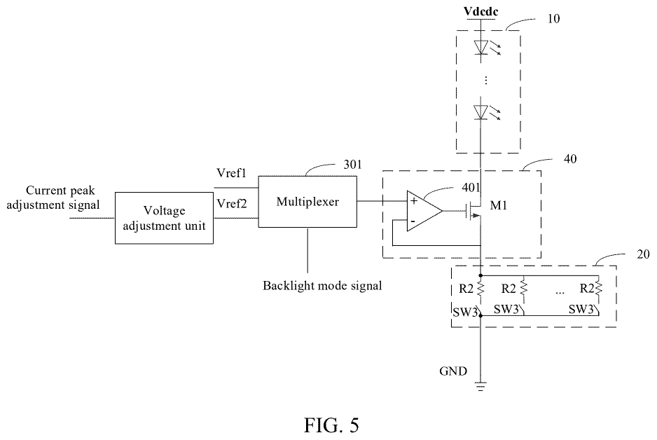

In another implementation, referring to FIG. 5, the current peak adjustment module 30 includes a multiplexer 301 and a voltage adjustment unit 302;
an input terminal of the voltage adjustment unit 302 receives the current peak adjustment signal and outputs a second reference voltage Vref2 based on the current peak adjustment signal;
a first terminal of the multiplexer 301 receives a first reference voltage Vref1, a second terminal of the multiplexer receives the second reference voltage Vref2, an output terminal of the multiplexer is coupled to the first input terminal of the operational amplifier 101, and a control terminal of the multiplexer receives the backlight mode signal, where a voltage value of the second reference voltage Vref2 is greater than a voltage value of the first reference voltage Vref1; and
the multiplexer 301 is configured to:
if the backlight mode information indicates a normal working mode, control the output terminal of the multiplexer to output the first reference voltage Vref1; and
if the backlight mode information indicates a black frame insertion mode, control the output terminal of the multiplexer to output the second reference voltage Vref2.

In an example, the voltage value of the second reference voltage Vref2 is L times the voltage value of the first reference voltage Vref1, and L is a current adjustment coefficient. In some examples, the current adjustment coefficient may also be correspondingly set based on the grayscale level of the LED string 10, which is not limited in the present invention.

In this case, the voltage at the first terminal of the local dimming module 20 is the first reference voltage Vref1 or the second reference voltage Vref2. In this case, in an implementation, referring to FIG. 5, the local dimming unit includes a second resistor R2 and a third switch SW3; and
a first terminal of each second resistor R2 is coupled to the source of the first MOS transistor M1, and a second terminal of each second resistor R2 is grounded by using the corresponding third switch SW3.

In this embodiment, if a value of a voltage output by the current peak adjustment module 30 remains unchanged, the current flowing through the LED string 10 changes with a quantity of second resistors R2 connected in parallel, where the quantity of second resistors R2 connected in parallel corresponds to different grayscale levels; and
if the quantity of second resistors R2 connected in parallel in the local dimming module 20 remains unchanged, the current flowing through the LED string 10 changes with the value of the voltage output by the current peak adjustment module 30.

In conclusion, the current flowing through the LED string 10 may be controlled by using the local dimming module 20 and/or the current peak adjustment module 30. In a circuit design, a characteristic of an internal circuit of the local dimming module 20 is used, and display brightness of a backlight system in a black frame insertion mode is improved by adjusting the value of the peak output current flowing through the LED string 10 without affecting a local dimming signal (which may also be understood as not affecting a working state of the local dimming module 20).

Generally, a voltage value of a voltage source connected to the LED string 10 in series is relatively high (that is, the LED string 10 is powered by a high voltage). In the foregoing implementation, the first MOS transistor M1 is used as a high-voltage transistor.

In another implementation, the first MOS transistor M1 may also be used as a low-voltage transistor, and the feedback module 40, the local dimming module 20, and the current peak adjustment module 30 are powered by a low voltage. In this case, high and low voltage isolation needs to be further performed on the circuit.

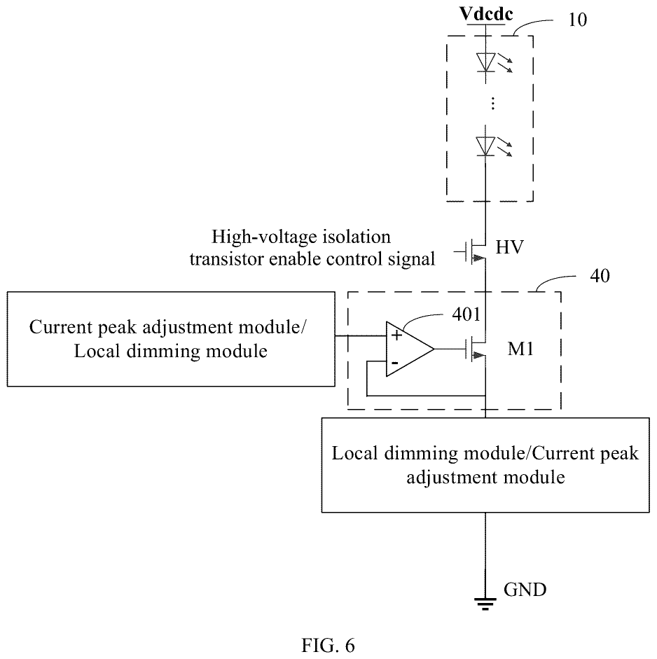

In an implementation, referring to FIG. 6, the backlight dimming circuit further includes an isolation MOS transistor HV; and
a first terminal of the isolation MOS transistor HV is coupled to the second terminal of the LED string 10, a second terminal of the isolation MOS transistor is coupled to the drain of the first MOS transistor M1, and a control terminal of the isolation MOS transistor receives a high-voltage isolation transistor enable control signal.

To control a current flowing through the LED string 10 at a specified time in the black frame insertion mode to be 0, in an example, the first MOS transistor M1 may be controlled to be disconnected. In another example, the isolation MOS transistor HV may also be controlled to be disconnected.

It should be understood that, in the present invention, how to control the current flowing through the LED string 10 at a specified time to be 0 is not specifically limited, and a person skilled in the art may set a proper circuit based on a requirement.

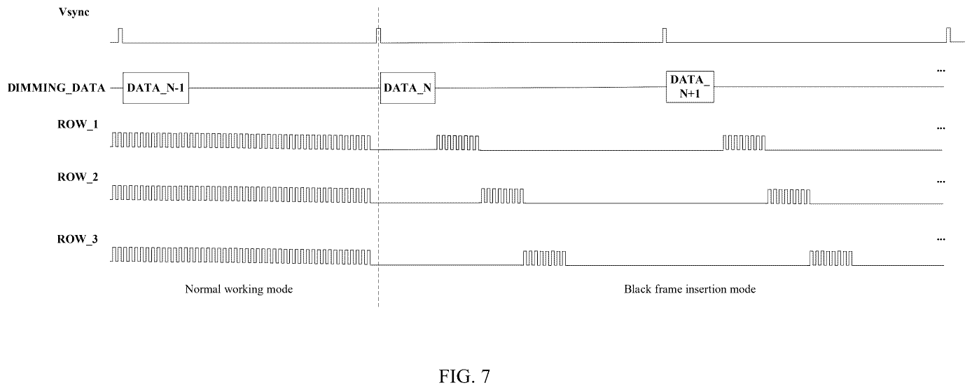

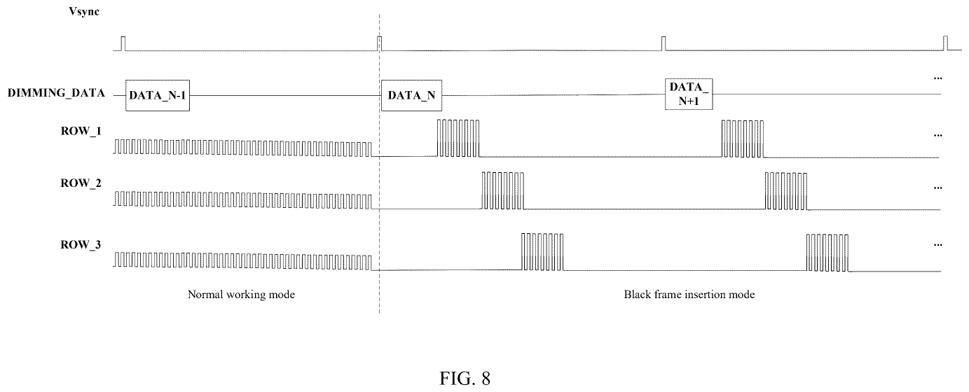

To better reflect a working effect of the present invention, a working effect of the backlight dimming circuit in the present invention is described with reference to waveform diagrams shown in FIG. 7 and FIG. 8.

The waveform diagram shown in FIG. 7 is a current waveform diagram obtained after a backlight dimming circuit in the prior art flows through the LED string 10 (three LED strings 10 are used as an example) in a normal working mode and a black frame insertion mode. The waveform diagram shown in FIG. 8 is a current waveform diagram obtained after a backlight dimming circuit shown in FIG. 1 flows through the LED string 10 in a normal working mode and a black frame insertion mode. Details are described as follows:

ROW_1 may be understood as a current signal that flows through a first LED string 10.

ROW_2 may be understood as a current signal that flows through a second LED string 10.

ROW_3 may be understood as a current signal that flows through a third LED string 10.

DIMMING_DATA may be understood as the local dimming signal.

Vsync may be understood as a vertical synchronization signal.

On a display screen, reorientation time of each row of liquid crystals varies from the top to the bottom, and therefore, a time start point for inserting a black frame into each string needs to be different.

Referring to FIG. 7, in the prior art, time (that is, illumination time is different) for receiving a current by an LED string 10 corresponding to each row of liquid crystals can be correspondingly controlled based on different reorientation times of each row of liquid crystals starting from receiving of a vertical synchronization signal, so that the backlight circuit can reorient and match liquid crystals, thereby avoiding a problem of image blur caused by reorientation of liquid crystals and improving a display effect. However, in the black frame insertion mode, time occupied to insert a black frame into a data frame is relatively long, that is, time in which the LED string 10 is on is relatively short, and a value of a current received by the LED string 10 is the same as a value of a current received in the normal working mode. Therefore, in the black frame insertion mode, brightness of a displayed image is significantly reduced.

Referring to FIG. 8, in the circuit provided in the present invention, a value of a current received by the LED string 10 in the black frame insertion mode may be controlled based on a preset current adjustment coefficient, so that brightness of a displayed image is not reduced in the black frame insertion mode.

In addition, an embodiment of the present invention further provides a backlight system, including the LED string and the foregoing backlight dimming circuit.

In addition, an embodiment of the present invention further provides an electronic device, including the foregoing backlight dimming circuit. As an example, the device may be applied to a display screen, and certainly may be applied to another device that needs to perform backlight dimming.

In conclusion, in the embodiments of the present invention, backlight is provided for a screen by using an LED string, a local dimming module controls a grayscale level of the LED string, a current peak adjustment module adjusts a value of a peak output current flowing through the LED string, and a feedback module controls a voltage at a first terminal of the local dimming module to be equal to a voltage at a first terminal of the current peak adjustment module. A drain of a first MOS transistor is coupled to a second terminal of the LED string, and a source of the first MOS transistor is grounded by using the local dimming module or the current peak adjustment module. A first input terminal of an operational amplifier is coupled to the first terminal of the current peak adjustment module or the first terminal of the local dimming module, a second input terminal of the operational amplifier is coupled to the first terminal of the local dimming module or the first terminal of the current peak adjustment module, and an output terminal of the operational amplifier is coupled to a gate of the first MOS transistor. Therefore, display brightness of a backlight system in a black frame insertion mode is improved by adjusting the value of the peak output current flowing through the LED string without affecting a local dimming signal.

Finally, it should be noted that the foregoing embodiments are merely used to describe the technical solutions of the present invention, but are not intended to limit the technical solutions. Although the present invention is described in detail with reference to the foregoing embodiments, a person of ordinary skill in the art should understand that the technical solutions recorded in the foregoing embodiments can still be modified, or equivalent replacements can be made to some or all technical features in the technical solutions. However, these modifications or replacements do not make the essence of the corresponding technical solutions depart from the scope of the technical solutions in the embodiments of the present invention.

1. A backlight dimming circuit for adjusting a peak output current flowing through an LED string in a black frame insertion mode, characterized by comprising: a local dimming module, a current peak adjustment module, and a feedback module, wherein
the LED string comprises N LEDs connected in series, a first terminal of the LED string is coupled to a first voltage source, and the LED string is configured to provide backlight for a screen, wherein N is an integer greater than or equal to 1;
the local dimming module comprises a total of M local dimming units and configured to: receive a local dimming signal, and correspondingly control, based on the local dimming signal, i local dimming units to be connected in parallel, so as to control a grayscale level of the LED string, wherein the local dimming signal comprises dimming data information, M and i are integers, 1≤M, and 0≤i≤M;
the current peak adjustment module is configured to: receive a current peak adjustment signal and a backlight mode signal, and adjust, based on the current peak adjustment signal and the backlight mode signal, a value of the peak output current flowing through the LED string, wherein the current peak adjustment signal comprises current adjustment coefficient information, and the backlight mode signal comprises backlight mode information; and
the feedback module comprises a first MOS transistor and an operational amplifier, and is configured to control a voltage at a first terminal of the local dimming module to be equal to a voltage at a first terminal of the current peak adjustment module, wherein
a drain of the first MOS transistor is coupled to a second terminal of the LED string, and a source of the first MOS transistor is grounded by using the local dimming module or the current peak adjustment module; and
a first input terminal of the operational amplifier is coupled to the first terminal of the current peak adjustment module or the first terminal of the local dimming module, a second input terminal of the operational amplifier is coupled to the first terminal of the local dimming module or the first terminal of the current peak adjustment module, and an output terminal of the operational amplifier is coupled to a gate of the first MOS transistor.

2. The backlight dimming circuit according to claim 1, wherein the current peak adjustment module comprises a total of J current peak adjustment units; and
the current peak adjustment module is further configured to correspondingly control, based on the current peak adjustment signal, k current peak adjustment units to be connected in parallel, so as to adjust the value of the peak output current flowing through the LED string, wherein J and k are integers, 1≤J, and 0≤k≤J.

3. The backlight dimming circuit according to claim 2, wherein the current peak adjustment unit comprises a first resistor and a first switch; and
a first terminal of each first resistor is coupled to the source of the first MOS transistor, and a second terminal of each first resistor is grounded by using the corresponding first switch.

4. The backlight dimming circuit according to claim 3, wherein the local dimming module is further configured to output a first signal to the first input terminal of the operational amplifier based on the local dimming signal, wherein the first signal is used to represent the grayscale level of the LED string.

5. The backlight dimming circuit according to claim 2, wherein the current peak adjustment unit comprises a second MOS transistor; and
a drain of each second MOS transistor is coupled to the source of the first MOS transistor, and a source of each second MOS transistor is grounded.

6. The backlight dimming circuit according to claim 5, wherein the correspondingly controlling, based on the current peak adjustment signal, k current peak adjustment units to be connected in parallel is specifically:
correspondingly controlling, based on the current peak adjustment signal, gates of k second MOS transistors to be connected in sequence.

7. The backlight dimming circuit according to claim 6, further comprising a third MOS transistor, wherein
a drain of the third MOS transistor is coupled to the first terminal of the local dimming module, a source of the third MOS transistor is grounded, and a gate of the third MOS transistor is respectively coupled to a gate of a 1^{st} second MOS transistor and the drain of the third MOS transistor, and a second terminal of the local dimming module is coupled to a second voltage source.

8. The backlight dimming circuit according to claim 2, wherein the local dimming unit comprises a fifth MOS transistor; and
a drain of each fifth MOS transistor is coupled to the source of the first MOS transistor, and a source of each fifth MOS transistor is grounded.

9. The backlight dimming circuit according to claim 8, wherein the correspondingly controlling, based on the local dimming signal, i local dimming units to be connected in parallel is specifically:
correspondingly controlling, based on the local dimming signal, gates of i fifth MOS transistors to be connected in sequence.

10. The backlight dimming circuit according to claim 9, further comprising a fourth MOS transistor, wherein the current peak adjustment unit comprises a current source unit and a second switch;
a first terminal of each current source unit is coupled to a third voltage source, and a second terminal of each current source unit is respectively coupled to the first input terminal of the operational amplifier and a drain of the fourth MOS transistor by using the corresponding second switch; and
a source of the fourth MOS transistor is grounded, and a gate of the fourth MOS transistor is respectively coupled to a gate of an i^{th} fifth MOS transistor and the drain of the fourth MOS transistor.

11. The backlight dimming circuit according to claim 1, wherein the current peak adjustment module comprises a multiplexer and a voltage adjustment unit;
an input terminal of the voltage adjustment unit receives the current peak adjustment signal and outputs a second reference voltage based on the current peak adjustment signal;
a first terminal of the multiplexer receives a first reference voltage, a second terminal of the multiplexer receives the second reference voltage, an output terminal of the multiplexer is coupled to the first input terminal of the operational amplifier, and a control terminal of the multiplexer receives the backlight mode signal, wherein a voltage value of the second reference voltage is greater than a voltage value of the first reference voltage; and
the multiplexer is configured to:
if the backlight mode information indicates a normal working mode, control the output terminal of the multiplexer to output the first reference voltage; and
if the backlight mode information indicates a black frame insertion mode, control the output terminal of the multiplexer to output the second reference voltage.

12. The backlight dimming circuit according to claim 11, wherein the local dimming unit comprises a second resistor and a third switch; and
a first terminal of each second resistor is coupled to the source of the first MOS transistor, and a second terminal of each second resistor is grounded by using the corresponding third switch.

13. The backlight dimming circuit according to claim 1, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

14. A backlight system, comprising the LED string and the backlight dimming circuit according to claim 1.

15. An electronic device, comprising the backlight dimming circuit according to claim 1.

16. The backlight dimming circuit according to claim 2, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

17. The backlight dimming circuit according to claim 3, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

18. The backlight dimming circuit according to claim 4, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

19. The backlight dimming circuit according to claim 5, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.

20. The backlight dimming circuit according to claim 6, further comprising an isolation MOS transistor, wherein
a first terminal of the isolation MOS transistor is coupled to the second terminal of the LED string, a second terminal of the isolation MOS transistor is coupled to the drain of the first MOS transistor, and a control terminal of the isolation MOS transistor receives a high-voltage isolation transistor enable control signal.
